(19) United States
(12) Patent Application Publication
(10) Pub. No.: US 2017/0094582 A1
(43) Pub. Date: Mar. 30, 2017

(54) COMMUNICATION TERMINAL

(71) Applicant: NEC Corporation, Tokyo (JP)

(72) Inventors: Hirofumi UEDA, Tokyo (JP); Norihito FUJITA, Tokyo (JP); Norio YAMAGAKI, Tokyo (JP); Shunichi KINOSHITA, Tokyo (JP)

(73) Assignee: NEC Corporation, Tokyo (JP)

(21) Appl. No.: 15/126,776

(22) PCT Filed: Dec. 17, 2014
(86) PCT No.: PCT/JP2014/006283

§ 371 Date: Sep. 16, 2016

(30) Foreign Application Priority Data
Mar. 27, 2014 (JP) 2014-065634

(51) Int. Cl. H04W 40/24; H04L 12/935

(52) U.S. Cl. CPC H04W 40/24; H04L 49/3009; H04W 84/18

(57) ABSTRACT

A communication terminal in an ad hoc network has a wireless communication part, a lower layer protocol part operating on a lower layer of the network, and an upper layer protocol part operating on an upper layer of the network. The lower layer protocol part has a routing table holding route information including a destination IP address and a next hop IP address associated with each other. The upper layer protocol part has: an information sharing management part transmitting and receiving a message including an IP address of the local communication terminal to and from a neighbor communication terminal through the wireless communication part by broadcast communication; and a route information registration part registering, into the routing table, the route information including the IP address included in the message received by broadcast communication as the destination IP address and as the next hop IP address.

### TECHNICAL FIELD

The present invention relates to a communication terminal in an ad hoc network, a control method of a communication terminal, a program, and an ad hoc network system.

### BACKGROUND ART

In recent years, along with widespread use of mobile wireless communication terminals, it has become possible to easily build a network among a plurality of communication terminals on the go by using a wireless LAN. However, access points allowing use of a wireless LAN are placed at limited places such as stations and commercial buildings. Therefore, an ad hoc network, which is built by communication terminals each autonomously recognizing its peripheral communication terminals without the necessity of infrastructure such as access points, has drawn attention (see Patent Document 1, for example).

In order to build an ad hoc network, each communication terminal needs to generate a routing table by using a dedicated routing protocol for an ad hoc network. Such routing protocols are broadly classified into the following types: a proactive type; a reactive type; and a hybrid type. A proactive routing protocol previously generates a routing table before a communication request occurs, and examples of a proactive routing protocol are OLSR (Optimized Link State Routing), DSDV (Destination Sequenced Distance Vector), and the like. A reactive routing protocol generates a routing table after a communication request occurs, and examples of a reactive routing protocol is DSR (Dynamic Source Routing), AODV (Ad hoc On-Demand Distance Vector), and the like. A hybrid routing protocol is combination of a proactive routing protocol and a reactive routing protocol, and examples of a hybrid routing protocol are ZHLS (Zone-based Hierarchical Link State), and the like.

A routing protocol operates on Layer 3, which is a lower layer of a network. A routing protocol exchanges topology information with neighbor communication terminals by broadcast communication and generates route information that forms a routing table. Route information shows a correspondence relation between a destination IP address and a next hop IP address.

A routing table is used when unicast communication with a specific communication terminal designated is requested by an application which operates on Layers 5 to 7, which are upper layers of a network. To be specific, when receiving a request for unicast communication, a wireless communication part of a communication terminal searches a routing table for a next hop IP address corresponding to a destination IP address, and transmits a communication message addressed to the destination IP address to a neighbor communication terminal having the next hop IP address. The neighbor communication terminal having received the communication message notifies an application which operates in the communication terminal itself of the received communication message in a case where the destination IP address is the IP address of the communication terminal itself. On the other hand, in a case where the destination IP address is not the IP address of the communication terminal itself, the communication terminal acquires a next hop IP address corresponding to the destination IP address from the routing table of the communication terminal itself, and transfers the communication message to a neighbor communication terminal having the acquired next hop IP address. Thus, the communication message is finally delivered to a communication terminal having the destination IP address.

On the other hand, as a first related technique relating to the present invention, it is proposed to, among communication terminals of an ad hoc network, exchange topology information by using a routing protocol on the lower layer and also exchange information such as node information, position information and a held content list on the upper layer (see Patent Document 2, for example). Moreover, according to the first related technique, when a change of the status of a neighbor communication terminal on the lower layer is detected, it is determined whether to transmit a message for information sharing on the upper layer on the basis of the detected change of the status of the neighbor communication terminal, and the load of messages for information sharing in the upper layer protocol is thereby reduced.
Patent Document 1: Japanese Patent Publication No. JP4839993
Patent Document 2: Japanese Patent Publication No. JP5257703

As described above, a communication terminal in an ad hoc network generates a routing table by exchanging topology information with neighbor communication terminals by using a routing protocol on a lower layer. Therefore, when a routing protocol stops or is stopped for a certain reason, a routing table cannot be generated and unicast communication is difficult.

### SUMMARY

An object of the present invention is to provide a communication terminal which solves the abovementioned problem, namely, a problem that, when a routing protocol on a lower layer of a network is not operating, a routing table cannot be generated and unicast communication is difficult.

A communication terminal as a first aspect of the present invention is a communication terminal in an ad hoc network, and the communication terminal includes:

a wireless communication part;

a lower layer protocol part operating on a lower layer of the network; and

an upper layer protocol part operating on an upper layer of the network.

The lower layer protocol part has a routing table holding route information including a destination IP address and a next hop IP address associated with each other.

The upper layer protocol part has: an information sharing management part transmitting and receiving a message including an IP address of the local communication terminal to and from a neighbor communication terminal through the wireless communication part by broadcast communication; and a route information registration part registering, into the routing table, the route information including the IP address included in the message received by broadcast communication as the destination IP address and as the next hop IP address.

A control method of a communication terminal as a second aspect of the present invention is a control method of a communication terminal in an ad hoc network. The communication terminal includes a wireless communication part, a lower layer protocol part operating on a lower layer of the network, and an upper layer protocol part operating on an upper layer of the network. The lower layer protocol part has a routing table holding route information including a destination IP address and a next hop IP address associated with each other.

The control method includes: by the upper layer protocol part, transmitting and receiving a message including an IP address of the local communication terminal to and from a neighbor communication terminal through the wireless communication part by broadcast communication, and registering the route information into the routing table, the route information including the IP address included in the message received by broadcast communication as the destination IP address and as the next hop IP address.

An ad hoc network system as a third aspect of the present invention is an ad hoc network system configured by a plurality of communication terminals.

The plurality of communication terminals each includes a wireless communication part, a lower layer protocol part operating on a lower layer of the network, and an upper layer protocol part operating on an upper layer of the network.

The lower layer protocol part has a routing table holding route information including a destination IP address and a next hop IP address associated with each other.

The upper layer protocol part has: an information sharing management part transmitting and receiving a message including an IP address of the local communication terminal to and from a neighbor communication terminal through the wireless communication part by broadcast communication; and a route information registration part registering, into the routing table, the route information including the IP address included in the message received by broadcast communication as the destination IP address and as the next hop IP address.

A program as a fourth aspect of the present invention is a computer program including instructions for causing a computer forming a communication terminal in an ad hoc network to function as:

a wireless communication part;

a lower layer protocol part operating on a lower layer of the network; and

an upper layer protocol part operating on an upper layer of the network.

The lower layer protocol part has a routing table holding route information including a destination IP address and a next hop IP address associated with each other.

The upper layer protocol part has: an information sharing management part transmitting and receiving a message including an IP address of the local communication terminal to and from a neighbor communication terminal through the wireless communication part by broadcast communication; and a route information registration part registering, into the routing table, the route information including the IP address included in the message received by broadcast communication as the destination IP address and as the next hop IP address.

With the configurations described above, the present invention can generate a routing table and perform unicast communication as far as an upper layer protocol part is operating even if a routing protocol on a lower layer of a network is not operating.

### BRIEF DESCRIPTION OF DRAWINGS

FIG. 1 is a block diagram of a communication terminal according to a first exemplary embodiment of the present invention;

FIG. 2 is a flowchart showing an operation of an upper layer protocol part of the communication terminal according to the first exemplary embodiment of the present invention;

FIG. 3 is a flowchart showing an operation of the upper layer protocol part of the communication terminal according to the first exemplary embodiment of the present invention;

FIG. 4 is a diagram showing a network configuration for describing an operation of the first exemplary embodiment of the present invention;

FIG. 5 is a diagram showing a configuration example of a routing table of each communication terminal in the first exemplary embodiment of the present invention;

FIG. 6 is a block diagram of a communication terminal according to a second exemplary embodiment of the present invention;

FIG. 7 is a flowchart showing an operation of an upper layer protocol part of the communication terminal according to the second exemplary embodiment of the present invention;

FIG. 8 is a flowchart showing an operation of the upper layer protocol part of the communication terminal according to the second exemplary embodiment of the present invention;

FIG. 9 is a flowchart showing an operation of the upper layer protocol part of the communication terminal according to the second exemplary embodiment of the present invention;

FIG. 10 is a diagram showing a network configuration for describing an operation of the second exemplary embodiment of the present invention;

FIG. 11 is a diagram showing a configuration example of a storage part of each communication terminal in the second exemplary embodiment;

FIG. 12 is a diagram showing a configuration example of a routing table of each communication terminal in the second exemplary embodiment of the present invention;

FIG. 13 is a diagram showing a configuration example of a storage part of each communication terminal in the second exemplary embodiment of the present invention;

FIG. 14 is a diagram showing a network configuration for describing an operation of the second exemplary embodiment of the present invention;

FIG. 15 is a diagram showing a configuration example of a storage part of each communication terminal in the second exemplary embodiment of the present invention;

FIG. 16 is a diagram showing a configuration example of a routing table of each communication terminal in the second exemplary embodiment of the present invention;

FIG. 17 is a diagram showing a configuration example of a storage part of each communication terminal in the second exemplary embodiment of the present invention; and

FIG. 18 is a block diagram of a communication terminal according to a third exemplary embodiment of the present invention.

### EXEMPLARY EMBODIMENTS

Next, exemplary embodiments of the present invention will be described in detail referring to the drawings.

### First Exemplary Embodiment

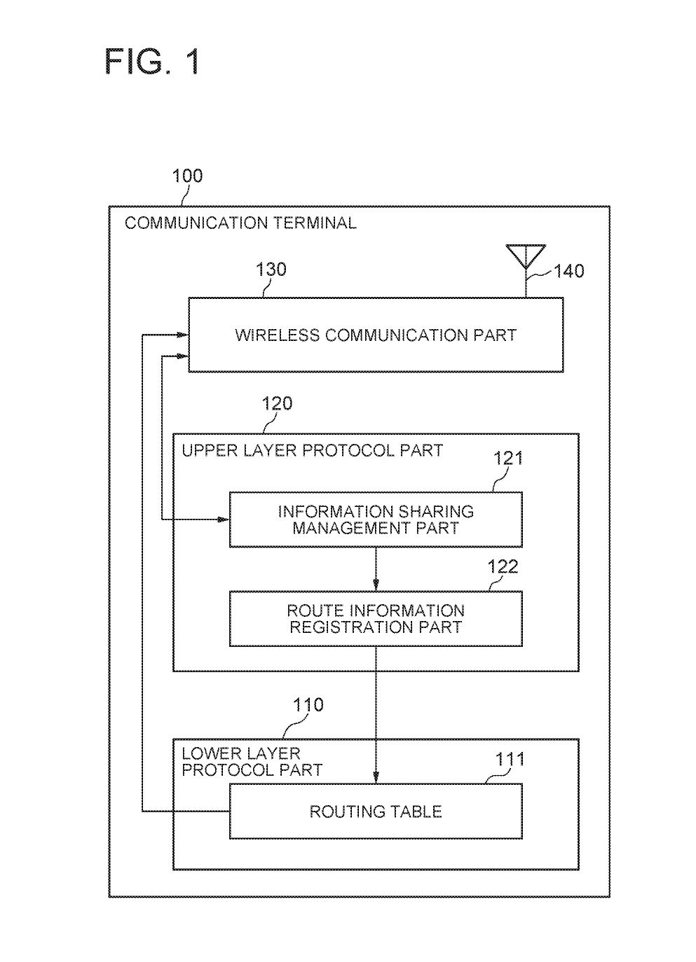

Referring to FIG. 1, a communication terminal 100 according to a first exemplary embodiment of the present invention has a function as one node in a wireless ad hoc network. The communication terminal 100 has a lower layer protocol part 110, an upper layer protocol part 120, a wireless communication part 130, and an antenna 140.

The lower layer protocol part 110 lies on a relatively lower layer in a network as compared with the upper layer protocol part 120. For example, the lower layer protocol part 110 operates on Layer 3 of the OSI Reference Model. The lower layer protocol part 110 has a routing table 111. The routing table 111 has a function of holding route information associating a destination IP address with a next hop IP address.

The upper layer protocol part 120 lies on a relatively upper layer in a network as compared with the lower layer protocol part 110. For example, the upper layer protocol part 120 operates on Layers 5 to 7 of the OSI Reference Model. The upper layer protocol part 120 has an information sharing management part 121 and a route information registration part 122.

The information sharing management part 121 has a function of transmitting and receiving messages for information sharing to and from neighbor communication terminals by broadcast communication. In this exemplary embodiment, the IP address of the local communication terminal is shared information. Meanwhile, the shared information may include other information in addition to the IP address of the local communication terminal. Examples of the other shared information are the user ID of the local communication terminal, position information of the local communication terminal, a list of contents held by the local communication terminal, and so on. Moreover, the information sharing management part 121 has a function of exchanging messages for individually sharing information by unicast communication with another communication terminal identified with the acquired IP address. Examples of the individually shared information are contents written in the content list, and so on.

The route information registration part 122 has a function of receiving, from the information sharing management part 121, an IP address included in a message received from a neighbor communication terminal by broadcast communication, generating route information having the IP address as a destination IP address and as a next hop IP address, and registering the route information into the routing table 111.

The wireless communication part 130 has a function of transmitting and receiving communication messages to and from other communication terminals by radio. At the time of transmission, the wireless communication part 130 generates a packet of a communication message, executes a process such as adding a header and an error detection code to the generated packet, generates a modulated signal of a frequency band of a carrier wave from the processed data, and transmits the modulated signal as a radio signal from the antenna 140. On the other hand, at the time of reception, the wireless communication part 130 demodulates a radio signal received by the antenna 140, decodes a packet of a communication message, and generates a communication message after confirmation of absence of an error based on an error detection signal. The messages transmitted and received by the information sharing management part 121 by broadcast communication to and from neighbor communication terminals are transmitted and received through the wireless communication part 130. Moreover, messages transmitted and received by unicast communication between the communication terminal 100 and another communication terminal are also transmitted and received through the wireless communication part 130. The wireless communication part 130 does not refer to the routing table 111 at the time of transmission by broadcast communication. On the contrary, at the time of transmission by unicast communication, the wireless communication part 130 refers to the routing table 111 to perform route solution, and determines a neighbor communication terminal of a next hop to which a message is transmitted.

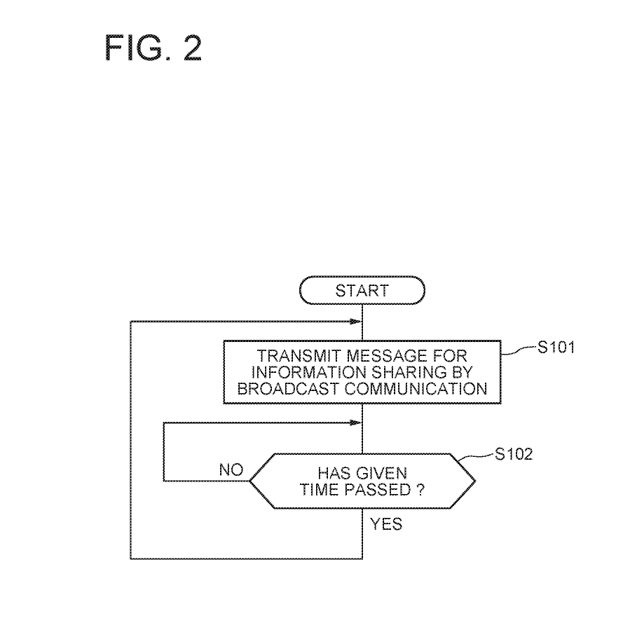

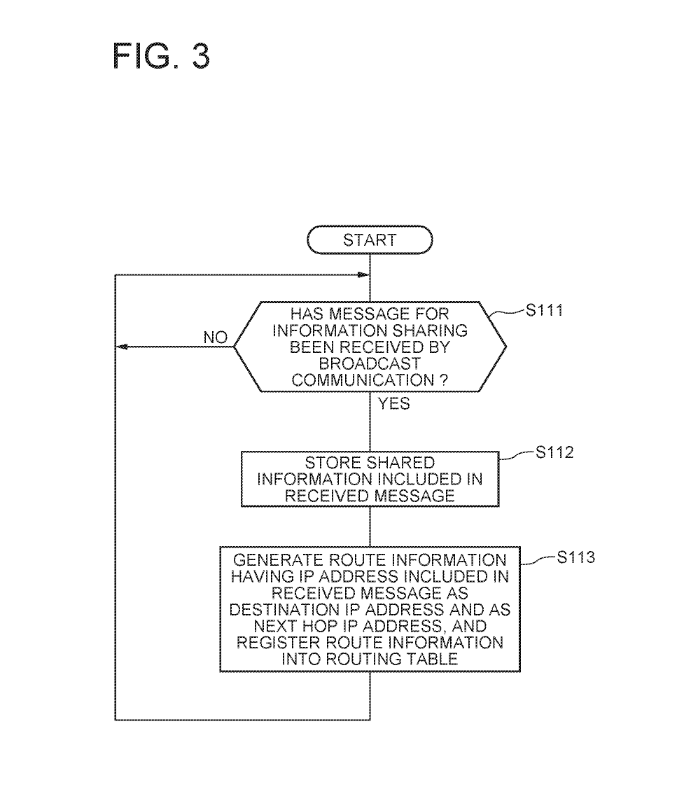

Next, an operation of the communication terminal 100 according to this exemplary embodiment will be described referring to flowcharts of FIGS. 2 and 3. FIGS. 2 and 3 are flowcharts showing examples of an operation of the upper layer protocol part 120 of the communication terminal 100.

When the communication terminal 100 is started up, for example, the communication terminal 100 is turned on, the upper layer protocol part 120 starts execution of processes shown in FIGS. 2 and 3. First, the information sharing management part 121 of the upper layer protocol part 120 transmits a message for information sharing to other communication terminals around the local communication terminal by broadcast communication (step S101). A transmitted message includes at least the IP address of the communication terminal 100 as shared information. The information sharing management part 121 waits until a given time passes after transmitting the message (step S102) and, when the given time passes, returns to step S101 to repeat the same process as mentioned above.

On the other hand, the upper layer protocol part 120 executes a process shown in FIG. 3 in parallel with the process shown in FIG. 2. In the process shown in FIG. 3, first, the information sharing management part 121 of the upper layer protocol part 120 detects whether or not a message for information sharing transmitted by another communication terminal by broadcast communication has been received by the local communication terminal (step S111). In a case where the message has been received, the information sharing management part 121 stores shared information included in the received message (step S112). However, in a case where the same shared information is already stored, there is no need to store the shared information again. Further, the route information registration part 122 of the upper layer protocol part 120 generates route information having an IP address included in the received message as a destination IP address and as a next hop IP address, and registers the route information into the routing table 111 of the lower layer protocol part 110 (step S113). However, in a case where the same route information is already stored in the routing table 111, registration thereof may be omitted.

Below, an operation of this exemplary embodiment will be described more specifically with a simple example.

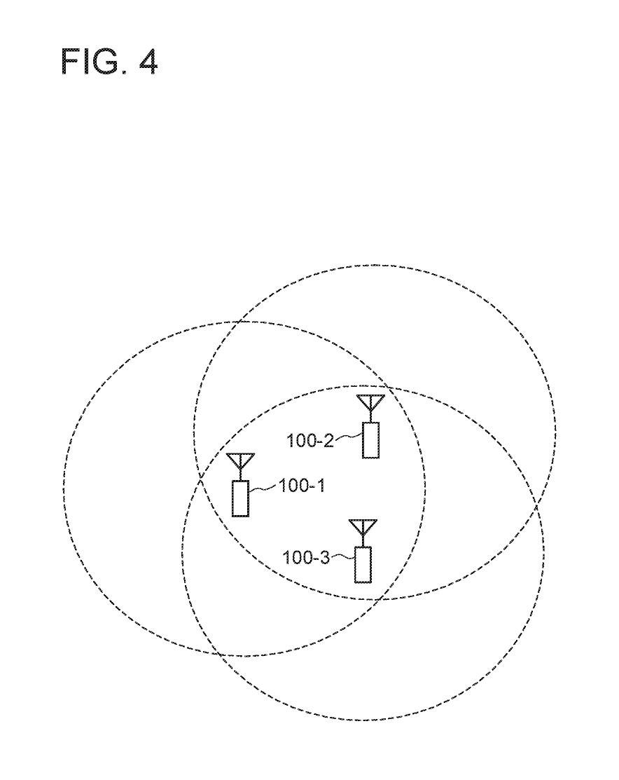

FIG. 4 shows a state that three communication terminals 100 having the same functions neighbor each other. A circle drawn with a dotted line centered at each communication terminal 100 shows a range where a radio wave from the communication terminal reaches (a wireless communication available range), and the other communication terminals 100 inside the circle centered at the communication terminal 100 are recognized as neighbor communication terminals. In the example of FIG. 4, in the wireless communication available range of each communication terminal 100, the other two communication terminals 100 are present.

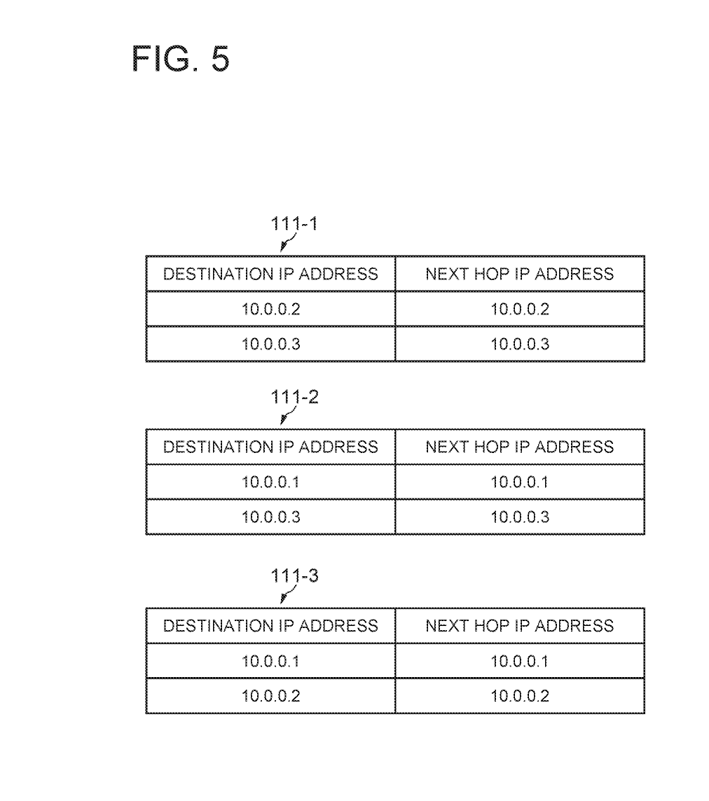

The upper layer protocol part 120 of each communication terminal 100 sends out a message including the IP address of the local communication terminal 100 by broadband communication. Further, when receiving a message by broadcast communication, the upper layer protocol part 120 of each communication terminal 100 stores an IP address included in the message, and also generates route information having the IP address as a destination IP address and as a next hop IP address and registers the route information into the routing table 111. Therefore, assuming communication terminals 100-1, 100-2 and 100-3 have IP addresses 10.0.0.1, 10.0.0.2 and 10.0.0.3, respectively, routing tables 111-1 to 111-3 of the communication terminals 100-1 to 100-3 are as shown in FIG. 5, for example. Consequently, each of the communication terminals 100-1 to 100-3 can perform unicast communication with the other two communication terminals.

Thus, in a case where the upper layer protocol part 120 is operating though the routing protocol on the lower layer of the network is not operating, the communication terminal 100 according to this exemplary embodiment can generate the routing table 111 and perform unicast communication. This is because the upper layer protocol part 220 has the route information registration part 122 that registers, into the routing table 111, route information having an IP address included in a message received by broadcast communication as a destination IP address and as a next hop IP address.

### Second Exemplary Embodiment

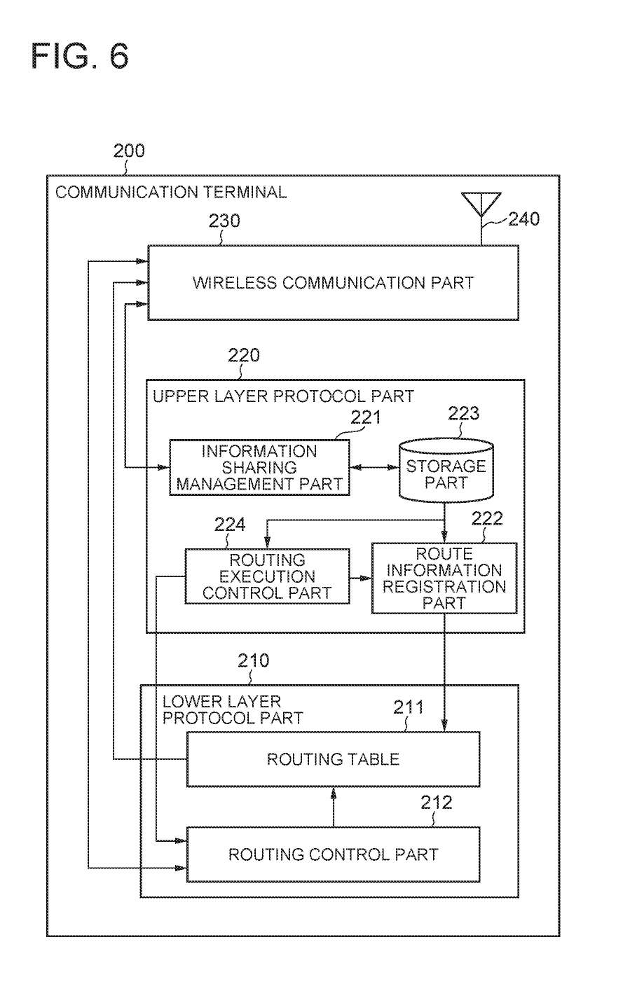

Referring to FIG. 6, a communication terminal 200 according to a second exemplary embodiment of the present invention has a function as one node in a wireless ad hoc network. The communication terminal 200 has a lower layer protocol part 210, an upper layer protocol 220, a wireless communication part 230, and an antenna 240.

The lower layer protocol part 210 lies on a relatively lower layer in a network as compared with the upper layer protocol part 220. For example, the lower layer protocol part 210 operates on Layer 3 of the OSI Reference Model. The lower layer protocol part 210 has a routing table 211 and a routing control part 212. The routing table 211 has the same function as the routing table 111 of the communication terminal 100 according to the first exemplary embodiment of the present invention.

The routing control part 212 has a function of exchanging topology information with a routing control part of a neighbor communication terminal in accordance with a routing protocol to generate route information and registering the route information into the routing table 211. In this exemplary embodiment, a proactive routing protocol is used. Meanwhile, a routing protocol to be used is not limited to a proactive type, and may be a reactive type or a hybrid type.

The upper layer protocol part 220 lies on a relatively upper layer in a network as compared with the lower layer protocol part 210. For example, the upper layer protocol part 220 operates on Layers 5 to 7 of the OSI Reference Model. The upper layer protocol part 220 has an information sharing management part 221, a route information registration part 222, a storage part 223, and a routing execution control part 224.

The information sharing management part 221 has a function of transmitting and receiving a message for information sharing to and from a neighbor communication terminal by broadcast communication. In this exemplary embodiment, information shared in messages transmitted and received by broadcast communication is node information which is composed of the IP address of the local communication terminal, the IP address of a recognized neighbor communication terminal and a list of contents held by the local communication terminal. Meanwhile, information shared in messages transmitted and received by broadcast communication may include information other than the abovementioned information. Examples of other shared information are the user ID of the local communication terminal, position information of the local communication terminal, and the like.

Further, the information sharing management part 221 has a function of exchanging a message for individually sharing information with another communication terminal identified with the IP address by unicast communication. In this exemplary embodiment, shared information transmitted and received by unicast information is a content held by the local communication terminal. The kind of the content may be any kind, for example, a voice data file, an image data file, a multimedia data file, or the like. However, shared information transmitted and received by unicast communication is not limited to the content held by the local communication terminal, and may be any information.

The storage part 223 has a function of storing data shared among a plurality of communication terminals. In this exemplary embodiment, node information received from a neighbor communication terminal by broadcast communication and a content held by the local communication terminal are stored in the storage part 223. The storage part 223 is formed of a RAM, a hard disk, and the like.

The routing execution control part 224 has a function of controlling the operation of the routing control part 212. To be specific, the routing execution control part 224 has a function of stopping the operation of the routing control part 212. For example, in a case where the routing control part 212 is configured to be automatically started up at the time of startup of the communication terminal 200, the routing control part 224 has a function of immediately stopping the started routing control part 212. Moreover, the routing execution control part 224 may have a function of stopping the routing control part 212 at any time point while the communication terminal 200 is operating. The control of stop of the routing control part 212 may be executed when an instruction to stop the routing protocol is input by the user (person) of the communication terminal 200, or may be executed at a time point that the routing execution control part 224 detects satisfaction of a given condition for stop. An example of the given condition for stop is a condition that there is no other communication terminal that is two hops or more away from the local communication terminal and the neighbor communication terminal. Such a condition for stop can be detected on the basis of node information received from the neighbor communication terminal by broadcast communication.

Further, the routing execution control part 224 has a function of restarting the operation of the routing control part 212. For example, the routing execution control part 224 may be configured to restart the operation of the routing control part 212 when an instruction to restart the routing protocol is input by the user (person) of the communication terminal 200. Alternatively, the routing execution control part 224 may be configured to restart the operation of the routing control part 212 when detecting satisfaction of a given condition for start. An example of the given condition for start is a condition that there is another communication terminal that is two hops or more away from the local communication terminal and the neighbor communication terminal. As with the abovementioned condition for stop, the condition for start can be detected on the basis of node information received from the neighbor communication terminal by broadcast communication.

Further, the routing execution control part 224 has a function of notifying the route information registration part 222 of an operation status of the routing control part 212.

The route information registration part 222 has a function of receiving an IP address included in a message received from a neighbor communication terminal by broadcast communication, from the information sharing management part 221 via the storage part 223, generating route information having the IP address as a destination IP address and as a next hop IP address, and registering the route information into the routing table 211. Moreover, the route information registration part 222 has a function of receiving notification of the operation status of the routing control part 212 from the routing execution control part 224 and, only when the routing control part 212 is in the stop state, registering the route information into the routing table 211.

The wireless communication part 230 has the same function as the wireless communication part 130 of the communication terminal 100 according to the first exemplary embodiment of the present invention.

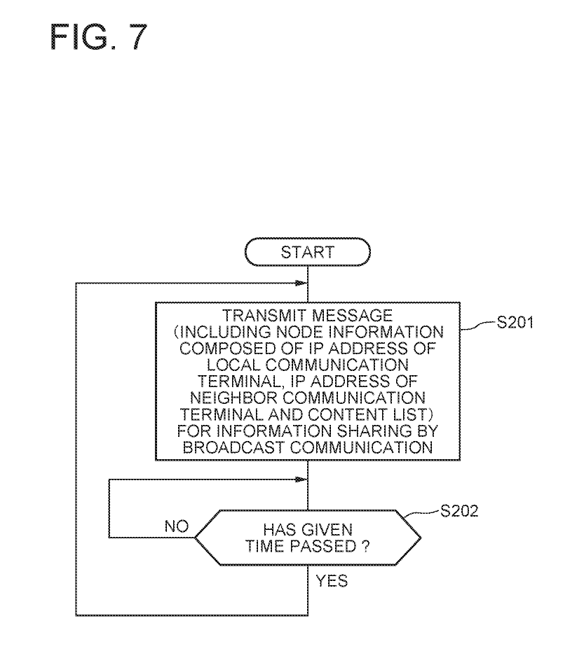

Next, an operation of the communication terminal 200 according to this exemplary embodiment will be described referring to flowcharts shown in FIGS. 7 to 9. FIGS. 7 to 9 are flowcharts showing examples of the operation of the upper layer protocol part 220 of the communication terminal 200.

When the communication terminal 200 is started up, for example, the communication terminal 200 is turned on, the upper layer protocol part 220 starts execution of processes shown in FIGS. 7, 8 and 9.

Referring to FIG. 7, the information sharing management part 221 of the upper layer protocol part 220 transmits a message for information sharing to another communication terminal around the local communication terminal by broadcast communication (step S201). A transmitted message includes node information. Node information is composed of the IP address of the local communication terminal 200, the IP address of a neighbor communication terminal recognized by the local communication terminal 200, and a list of contents held by the local communication terminal 200. After transmitting the message, the information sharing management part 221 waits until a given time passes (step S202) and, when the given time passes, returns to step S201 to repeat the same process as described above.

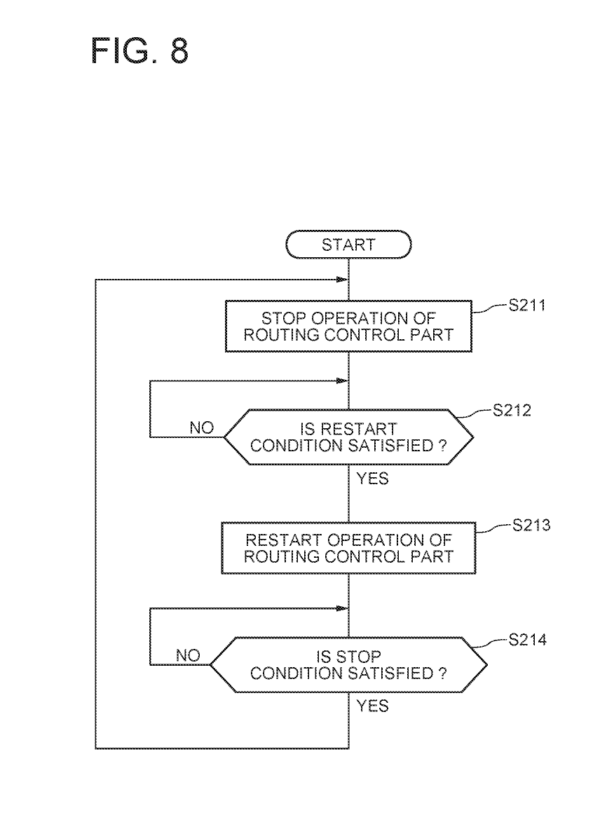

Referring to FIG. 8, the routing execution control part 224 of the upper layer protocol part 220 stops the operation of the routing control part 212 immediately after startup of the communication terminal 200 (step S211). Next, the routing execution control part 224 waits until a condition for restarting the operation of the routing control part 212 is satisfied (step S213). Then, when the condition for restarting is satisfied, the routing execution control part 224 restarts the operation of the routing control part 212 (step S213). Next, the routing execution control part 224 waits until a condition for stopping the operation of the routing control part 212 (step S214). Then, when the condition for stopping is satisfied, the routing execution control part 224 returns to the process of step S211 to stop the operation of the routing control part 212. After that, the same operation as described above is continued.

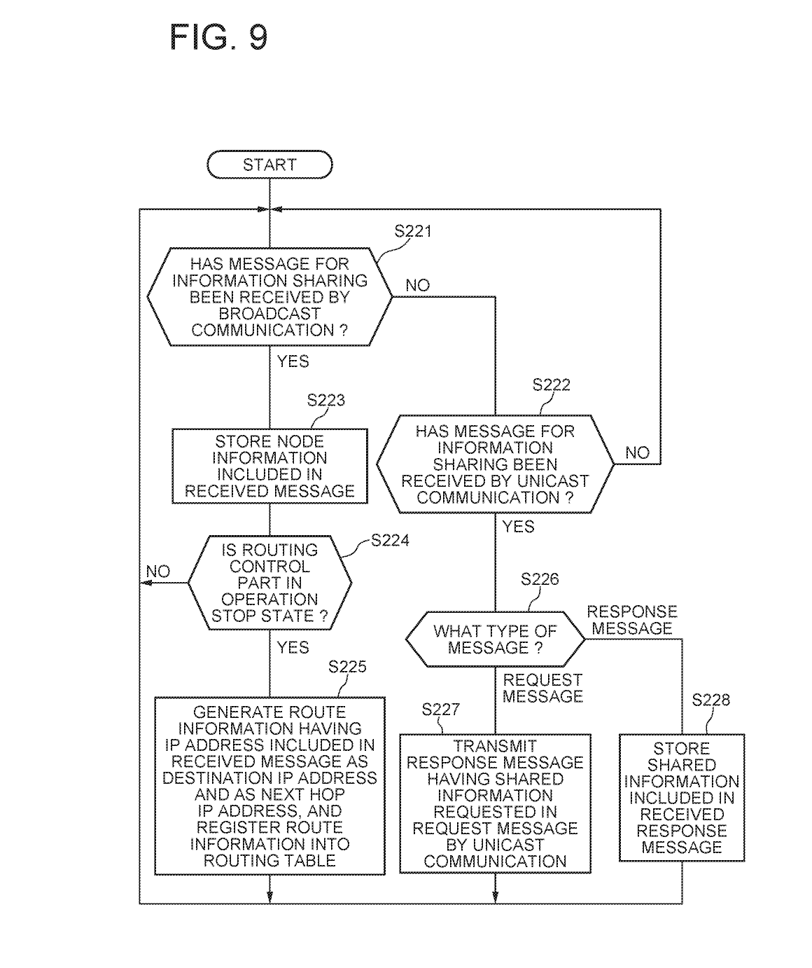

Referring to FIG. 9, the information sharing management part 221 of the upper layer protocol part 220 determines whether or not a message for information sharing has been received by broadcast communication, and determines whether or not a message for information sharing has been received by unicast communication (steps S221 and S222).

In a case where a message for information sharing transmitted from another communication terminal by broadcast communication has been received, the information sharing management part 221 stores node information included in the received message into the storage part 223 (step S223). However, in a case where the same node information is already stored, there is no need to store the node information again. Then, the route information registration part 222 of the upper layer protocol part 220 determines whether or not the routing control part 212 is in the operation stop state on the basis of notification from the routing execution control part 224 (step S224) and, only when the routing control part 212 is in the stop state, the route information registration part 222 retrieves an IP address of the node information included in the received message (the IP address of a communication terminal neighboring the local communication terminal) from the storage part 223, generates route information having the retrieved IP address as a destination IP address and as a hop IP address, and registers the route information into the routing table 211 (step S225). However, in a case where the same route information is already recorded in the routing table 211, registration thereof may be omitted.

Further, in a case where a message for information sharing transmitted from another communication terminal by unicast communication has been received, the information sharing management part 221 determines the type of the received message (step S226). Then, in a case where the type of the message is a request message for requesting shared information, the information sharing management part 221 transmits a response message having content as the requested shared information to the other communication terminal of the request source by unicast communication (step S227). On the other hand, the type of the message is a response message to a request message transmitted from the local communication terminal by unicast communication, the information sharing management part 221 stores content included as shared information in the response message into the storage part 223 (step S228).

Below, an operation of this exemplary embodiment will be described more specifically with a simple example.

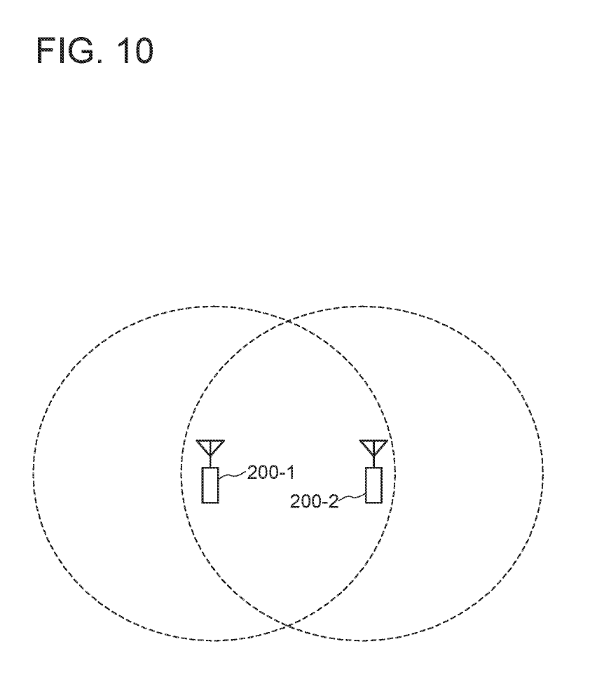

FIG. 10 shows a state that two communication terminals 200 having the same functions neighbor each other. A circle drawn with a dotted line centered at each communication terminal 200 shows a range where a radio wave from the communication terminal reaches (a wireless communication available range), and the other communication terminal 200 inside the circle centered at the communication terminal 200 is recognized as a neighbor communication terminal. In the example of FIG. 10, in the wireless communication available range of each communication terminal 200, the other one communication terminal 200 is included.

The routing control part 212 of the lower layer protocol part 210 of each communication terminal 200 is in the stop state in accordance with an instruction from the routing execution control part 224. On the other hand, the information sharing management part 221 of the upper layer protocol part 220 of each communication terminal 200 regularly sends out a message having node information composed of the IP address of the local communication terminal 200, the IP address of a recognized neighbor communication terminal and a list of contents held by the local communication terminal by broadcast communication. Herein, a communication terminal 200-1 does not recognize a neighbor communication terminal 200-2 in the initial state, and therefore, transmitted node information does not include the IP address of the neighbor communication terminal. However, after the communication terminal 200-1 receives node information from the communication terminal 200-2 and thereby recognizes the communication terminal 200-2, node information transmitted from the communication terminal 200-1 includes the IP address of the neighbor communication terminal 200-2. Then, when receiving a message by broadcast communication, the information sharing management part 221 of the upper layer protocol part 220 of each communication terminal 200 stores node information included in the message into the storage part 223.

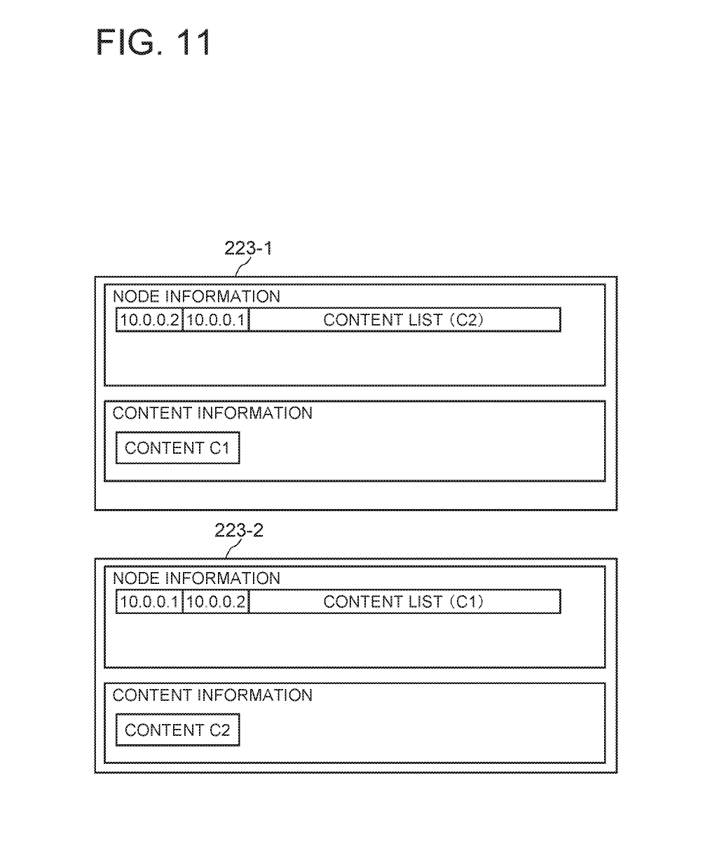

FIG. 11 shows an example of information held by storage parts 223-1 and 223-2 of the communication terminals 200-1 and 200-2. This example is based on assumption that the communication terminals 200-1 and 200-2 have IP addresses 10.0.0.1 and 10.0.0.2, respectively, the communication terminal 200-1 holds content C1, and the communication terminal 200-2 holds content C2. Referring to FIG. 11, in the storage part 223-1 of the communication terminal 200-1, node information received from the neighbor communication terminal 200-2 (the IP address of the neighbor communication terminal 200-2, the IP address of the neighbor communication terminal 200-1 recognized by the communication terminal 200-2, and a list (C2) of contents held by the neighbor communication terminal 200-2) and information of contents held by the local communication terminal 200-1 (content C1) are stored. In the storage part 223-2 of the communication terminal 200-2, node information received from the neighbor communication terminal 200-1 (the IP address of the neighbor communication terminal 200-1, the IP address of the neighbor communication terminal 200-2 recognized by the communication terminal 200-1, and a list (C1) of contents held by the neighbor communication terminal 200-1) and information of contents held by the local communication terminal 200-2 (content C2) are stored.

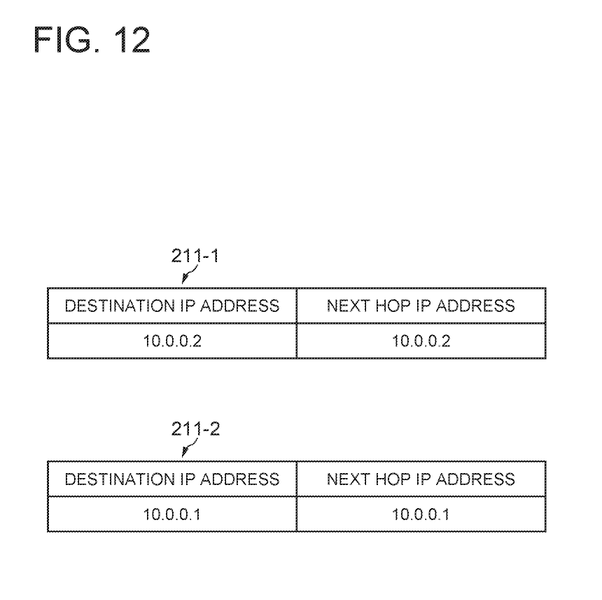

When node information as shown in FIG. 11 is newly stored in the storage part 223 of each communication terminal 200, the route information registration part 222 of the communication terminal 200 retrieves the IP address of the neighbor communication terminal 200 from the node information in the storage part 223, and generates route information having the IP address as a destination IP address and as a next hop IP address and registers the route information into the routing table 211. Therefore, the routing tables 211-1 and 211-2 of the communication terminals 200-1 and 200-2 are, for example, as shown in FIG. 12. Consequently, the communication terminals 200-1 and 200-2 can perform unicast communication with each other. Therefore, the communication terminals 200-1 and 200-2 can share content in accordance with the following procedure, for example.

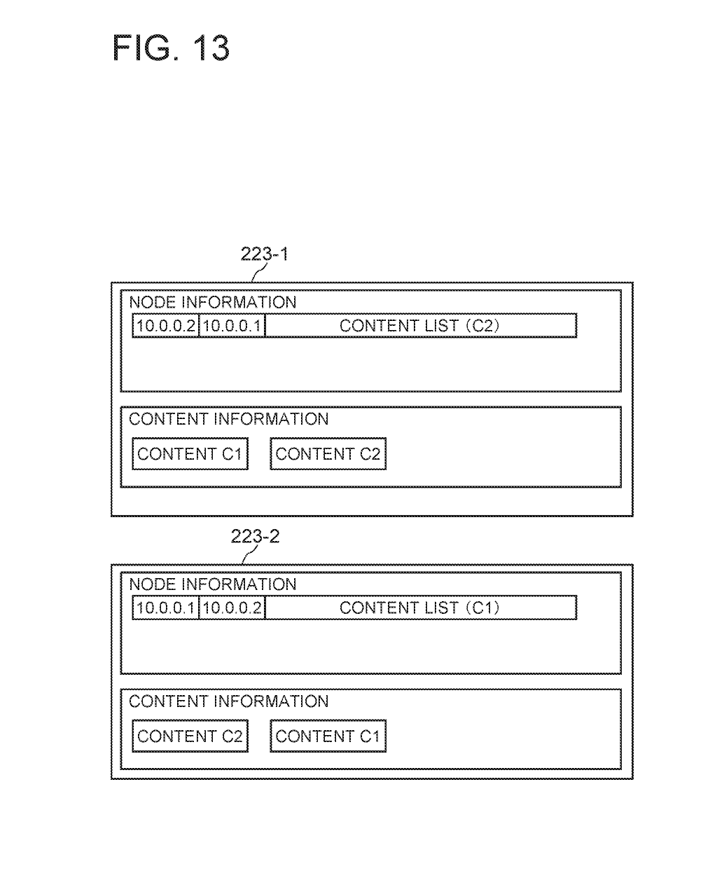

First, the information sharing management part 221 of the communication terminal 200-1 compares a list of contents in node information received from the communication terminal 200-2 with a list of contents held by the local communication terminal 200-1, and detects that the communication terminal 200-2 holds content C2, which is not in the local communication terminal. Next, the information sharing management part 221 of the communication terminal 200-1 transmits a message for requesting acquisition of the content C2 to the communication terminal 200-2 by unicast communication. The information sharing management part 221 of the communication terminal 200-2 having received the requesting message retrieves the requested content C2 from the storage part 223, and transmits a response message including the content C2 to the communication terminal 200-1 by unicast communication. The information sharing management part 221 of the communication terminal 200-1 having received the response message stores the content C2 included in the response message into the storage part 223. Likewise, the communication terminal 200-2 can acquire the content C1 from the communication terminal 200-1. As a result, the statuses of the storage parts 223-1 and 223-2 of the communication terminals 200-1 and 200-2 change from the statuses shown in FIG. 11 to the statuses shown in FIG. 13.

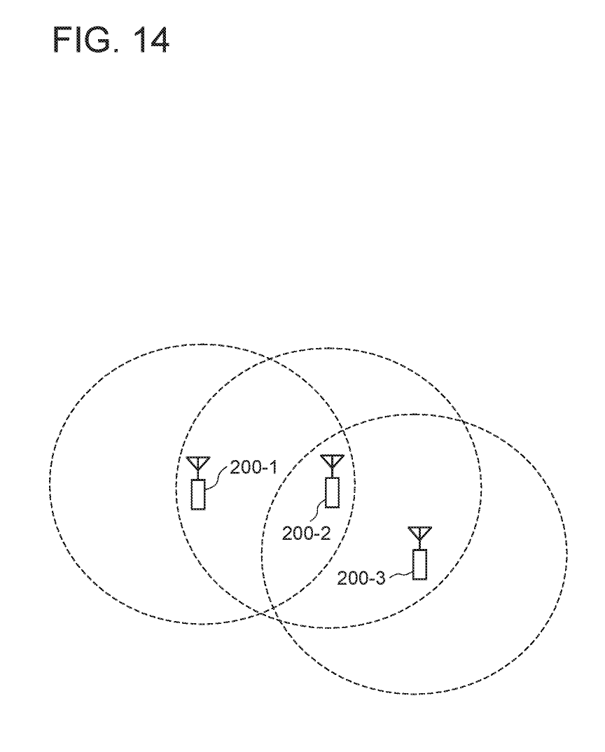

After that, as shown in FIG. 14, it is assumed that another communication terminal 200-3 moves into a region which is outside the wireless communication available range of the communication terminal 200-1 and is inside the wireless communication available range of the communication terminal 200-2. Herein, the routing control part 212 of the lower layer protocol part 210 of the communication terminal 200-3 is in the operation stop state in accordance with an instruction from the routing execution control part 224. The information sharing management part 221 of the upper layer protocol part 220 of the communication terminal 200-3 regularly sends out by broadcast communication a message having node information composed of an IP address of the local communication terminal 200, an IP address of a recognized neighbor communication terminal, and a list of contents held by the local communication terminal. In the initial state, the communication terminal 200-3 does not recognize the neighbor communication terminal 200-2, and therefore, an IP address of a neighbor communication terminal is not included in transmitted node information. Therefore, from the communication terminal 200-3, a message having node information composed of an IP address of the communication terminal 200-3 (for example, 10.0.0.3), an IP address of a neighbor communication terminal (none) and a list of held contents (for example, C3) is transmitted by broadcast communication.

The information sharing management part 221 of the communication terminal 200-2 having received the node information from the communication terminal 200-3 recognizes the communication terminal 200-3 as a neighbor communication terminal. As a result, IP addresses of neighbor communication terminals in node information newly transmitted from the communication terminal 200-2 by broadcast communication include the IP addresses of the communication terminals 200-1 and 200-3.

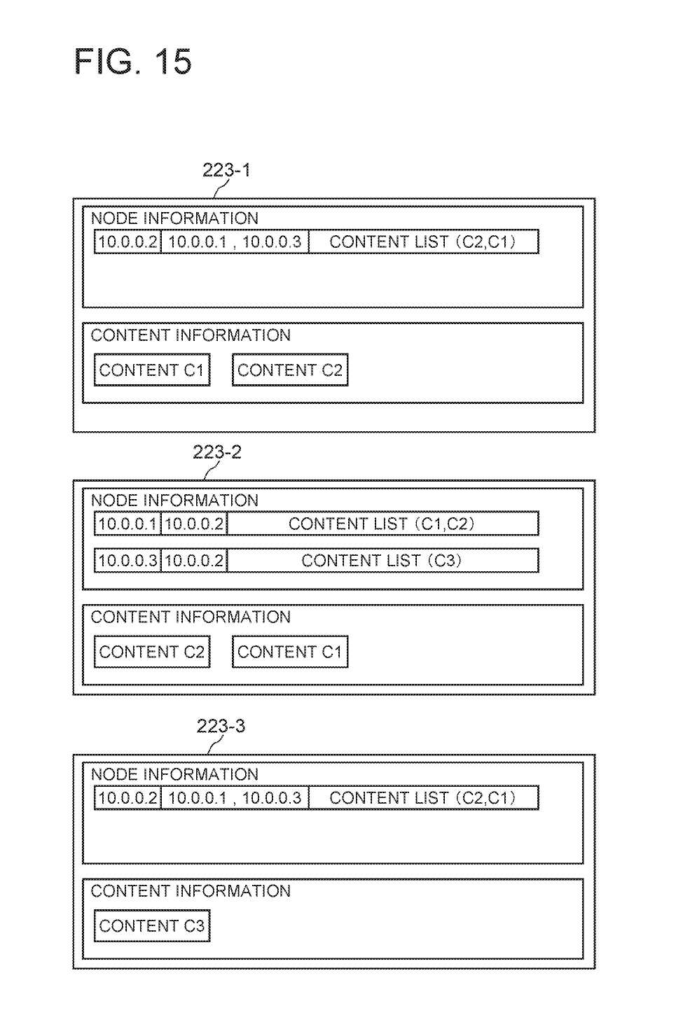

The communication terminal 200-3 having received the new node information from the communication terminal 200-2 updates the node information in the storage part 223 by reflecting the received node information thereon. As a result, the status of the storage part 223 of the communication terminal 200-3 becomes that of a storage part 223-3 shown in FIG. 15. Moreover, the communication terminal 200-1 having received the new node information from the communication terminal 200-2 updates the node information in the storage part 223 by reflecting the received node information thereon. As a result, the status of the storage part 223 of the communication terminal 200-1 becomes that of the storage part 223-1 shown in FIG. 15. Moreover, the communication terminal 200-2 having received the node information from the communication terminals 200-1 and 200-3 updates the node information in the storage part 223 by reflecting the received node information thereon. As a result, the status of the storage part 223 of the communication terminal 200-2 becomes that of the storage part 223-2 shown in FIG. 15.

The routing execution control part 224 of the communication terminal 200-1 recognizes, on the basis of the node information received from the communication terminal 200-2 stored in the storage part 223, that the communication terminal 200-2 having the IP address 10.0.0.2 neighbors the local communication terminal and the communication terminal 200-3 having the IP address 10.0.0.3 neighbors the communication terminal 200-2. Moreover, the routing execution control part 224 of the communication terminal 200-1 recognizes that the communication terminal 200-3 having the IP address 10.0.0.3 is not a communication terminal neighboring the local communication terminal because the communication terminal 200-1 has not received node information from the communication terminal 200-3. As a result, the routing execution control part 224 of the communication terminal 200-1 determines that a condition for starting the routing control part 212 is satisfied because the communication terminal 200-3 two hops or more away from the local communication terminal is present, and then restarts the operation of the routing control part 212. For the same reason, the routing execution control part 224 of the communication terminal 200-3 recognizes that the communication terminal 200-1 two hops or more away from the local communication terminal is present, and the restarts the operation of the routing control part 212.

On the other hand, the routing execution control part 224 of the communication terminal 200-2 recognizes, on the basis of the node information received from the communication terminals 200-1 and 200-3 stored in the storage part 223, that the communication terminal 200-1 having the IP address 10.0.0.1 and the communication terminal 200-3 having the IP address 10.0.0.3 neighbor the local communication terminal and that the communication terminal 200-1 and the communication terminal 200-3 do not neighbor each other. As a result, the routing execution control part 224 of the communication terminal 200-2 determines that a condition for starting the routing control part 212 is satisfied because there is no communication terminal two hops or more away from the local communication terminal and there are communication terminals two hops or more away from the respective communication terminals 200-1 and 200-3 neighboring the local communication terminal, and then restarts the operation of the routing control part 212.

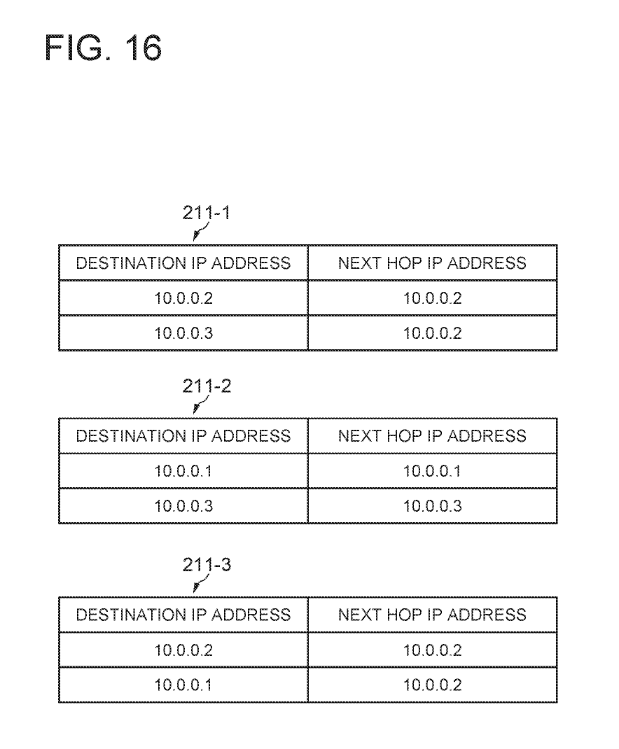

Upon restarting the operation, the routing control part 212 of each of the communication terminals 200-1 to 200-3 exchanges topology information with the neighbor communication terminal in accordance with the routing protocol, and generates route information in the routing table 211. As a result, the routing tables 211-1 to 211-3 of the communication terminals 200-1 to 200-3 are as shown in FIG. 16, for example. Consequently, the communication terminals 200-1 to 200-3 can perform unicast communication with each other. Therefore, the communication terminals 200-1 to 200-3 can share content in accordance with the following procedure, for example.

First, the information sharing management part 221 of the communication terminal 200-2 compares a list of contents included in node information received from the communication terminal 200-3 with a list of contents held by the local communication terminal 200-2, and detects that the communication terminal 200-3 holds content C3 that the local communication terminal does not hold. Next, the information sharing management part 221 of the communication terminal 200-2 transmits a message for requesting the content C3 to the communication terminal 200-3 by unicast communication. The information sharing management part 221 of the communication terminal 200-3 having received the request message retrieves the requested content C3 from the storage part 223, and transmits a response message including the content C3 to the communication terminal 200-2 by unicast communication. The information sharing management part 221 of the communication terminal 200-2 having received the response message stores the content C3 included in the response message into the storage part 223. Likewise, the communication terminal 200-3 can acquire contents C1 and C2 from the communication terminal 200-2. Moreover, the communication terminal 200-1 can acquire the content C3 from the communication terminal 200-2. As a result, the contents C1 to C3 are stored into the respective storage parts 223-1 to 223-3 of the communication terminals 200-1 to 200-3.

Meanwhile, each of the communication terminals 200-1 to 200-3 may acquire a content that the local communication terminal does not hold from the other communication terminal in accordance with the following procedure. First, the information sharing management part 221 of the communication terminal 200-1 transmits a message for requesting a content list to the communication terminal 200-3 by unicast communication. This message is delivered to the communication terminal 200-3 via the communication terminal 200-2 by multihop communication. The information sharing management part 221 of the communication terminal 200-3 having received the request message transmits a response message including a list (C3) of contents held by the local communication terminal to the communication terminal 200-1 by unicast communication. The information sharing management part 221 of the communication terminal 200-1 having received the response message compares a content list received from the communication terminal 200-3 with a content list held by the local communication terminal 200-1, and detects that the communication terminal 200-3 holds the content C3 that the local communication terminal does not hold. Next, the information sharing management part 221 of the communication terminal 200-1 transmits a message for requesting the content C3 to the communication terminal 200-3 by unicast communication. The information sharing management part 221 of the communication terminal 200-3 having received the request message retrieves the requested content C3 from the storage part 223, and transmits a response message including the content C3 to the communication terminal 200-1 by unicast communication. The information sharing management part 221 of the communication terminal 200-1 having received the response message stores the content C3 included in the response message into the storage part 223. Likewise, the communication terminal 200-3 can acquire contents C1 and C2 from the communication terminal 200-1. Moreover, the communication terminal 200-2 can acquire the content C3 from the communication terminal 200-3. As a result, the contents C1 to C3 are stored in the storage parts 223-1 to 223-3 of the communication terminals 200-1 to 200-3.

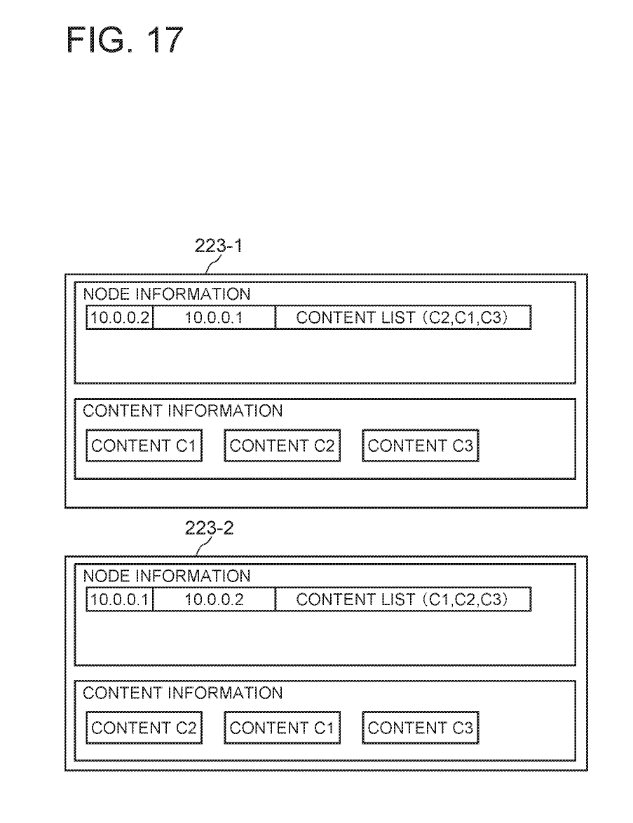

Assuming thereafter the communication terminal 200-3 moves outside the wireless communication available regions of the communication terminals 200-1 and 200-2 or is turned off and the status of the network thereby returns to the state shown in FIG. 10, the communication terminal 200-2 does not recognize the communication terminal 200-3 as a neighbor communication terminal, and a neighbor communication terminal in node information transmitted from the communication terminal 200-2 by broadcast communication is the communication terminal 200-1 alone. As a result, the storage parts 223 of the communication terminals 200-1 and 200-2 are as shown in FIG. 17. Therefore, the routing execution control part 224 of the communication terminal 200-1 recognizes, on the basis of the node information received from the communication terminal 200-2 stored in the storage part 223, that there is no other communication terminals two hops or more away from the local communication terminal and the neighbor communication terminal. As a result, the routing execution control part 224 of the communication terminal 200-1 determines that a condition for stopping the routing control part 212, and stops the operation of the routing control part 224. Likewise, the routing execution control part 224 of the communication terminal 200-2 stops the operation of the routing control part 212.

Thus, the operation of the routing control parts 212 of the communication terminals 200-1 and 200-2 stops, whereby it is possible to reduce power consumption by the communication terminals 200-1 and 200-2.

As described heretofore, according to this exemplary embodiment, as in the first exemplary embodiment, in a case where the upper layer protocol part 220 is operating though the routing protocol on the lower layer of the network is not operating, it is possible to generate the routing table 211 and perform unicast communication.

Further, according to this exemplary embodiment, the route information registration part 222 registers route information into the routing table 211 only when the routing control part 212 is not operating, so that it is possible to prevent useless operation, such as registration of the same route information into the routing table 211 by the routing control part 212 and the route information registration part 222.

Further, according to this exemplary embodiment, it is possible to cause the routing execution control part 224 of the upper layer protocol part 220 to control the operation status of the routing control part 212 of the lower layer protocol part 210. Specifically, by causing the routing execution control part 224 to stop the operation of the routing control part 212, it is possible to reduce power consumption of the local communication power.

Further, in this exemplary embodiment, the route information registration part 222 has only an ability to generate route information of another communication terminal only one hop away from the local communication terminal. Therefore, in a network where there are communication terminals two hops or more away from each other, unicast communication between the communication terminals two hops or more away from each other is difficult as the routing control part 212 remains in the stop state. Thus, in this exemplary embodiment, the routing execution control part 224 stops the operation of the routing control part in a case where there is no other communication terminal two hops or more away from the local communication terminal and the neighbor communication terminal, and restarts the operation of the routing control part in a case where there is another communication terminal two hops or more away from the local communication terminal and the neighbor communication terminal. Consequently, it is possible to cause the routing control part 212 to operate only in the minimum necessary case.

### Third Exemplary Embodiment

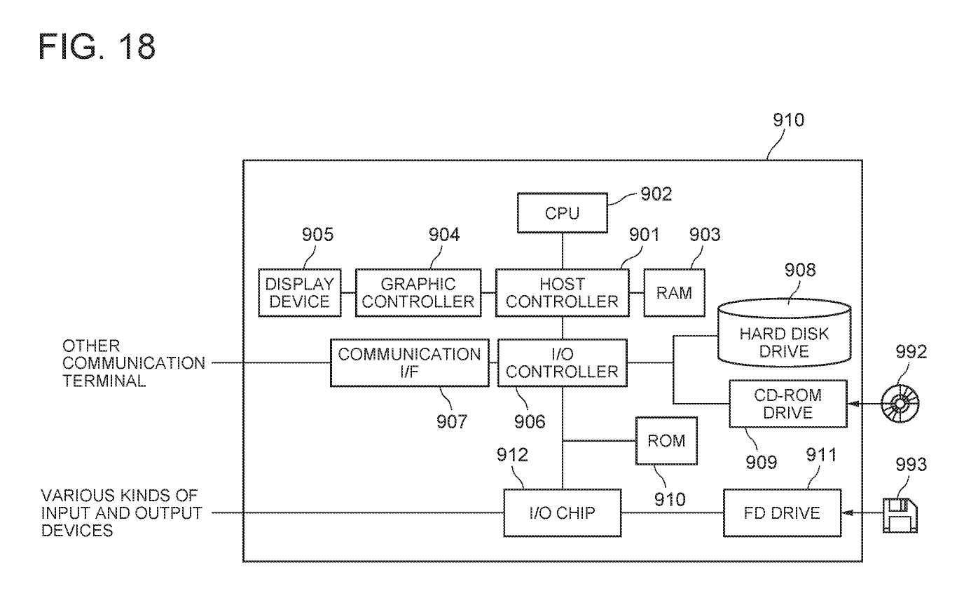

FIG. 18 shows an example of hardware configuration in the case of configuring each of the communication terminals according to the exemplary embodiments described above with an electronic information processing device such as a computer. A communication terminal 910 in this example includes a CPU (Central Processing Unit) peripheral part, an input and output part, and a legacy input and output part. The CPU peripheral part has a CPU 902, a RAM (Random Access Memory) 903, a graphic controller 904, and a display device 905, which are connected to each other by a host controller 901. The input and output part has a communication interface 907, a hard disk drive 908, and a CD-ROM (Compact Disk Read Only Memory) drive 909, which are connected to the host controller 901 by an input and output controller 906. The legacy input and output part has a ROM (Read Only Memory) 910, a flexible disk 911, and an input and output chip 912, which are connected to the input and output controller 906.

The host controller 901 connects the RAM 903 to the CPU 902 and the graphic controller 904 that access the RAM 903 at high transfer rates. The CPU 902 operates in accordance with programs stored in the ROM 910 and the RAM 903 to control the respective parts. The graphic controller 904 acquires image data generated by the CPU or the like on a frame buffer provided in the RAM 903, and causes the display device 905 to display. Alternatively, the graphic controller 904 may include a frame buffer which stores image data generated by the CPU 902 or the like.

The input and output controller 906 connects the host controller 901 to the hard disk drive 908, the communication interface 907 and the CD-ROM drive 909 that are comparatively high-speed input and output devices. The hard disk drive 908 stores a program and data used by the CPU 902. The communication interface 907 connects to another communication terminal to transmit and receive a program or data. The CD-ROM drive 909 retrieves a program or data from a CD-ROM 992 and provides the hard disk 908 and the communication interface 907 with the program or the data via the RAM 903.

The ROM 910, the flexible disk drive 911 and the input and output chip 912 that are comparatively low-speed input and output devices are connected to the input and output controller 906. The ROM 910 stores a boot program executed at the time of startup by the communication terminal 910, a program depending on hardware of the communication terminal 910, or the like. The flexible disk drive 911 retrieves a program or data from a flexible disk 993, and provides the hard disk drive 908 and the communication interface 907 with the program or the data via the RAM 903. The input and output chip 912 connects the flexible disk drive 911, or connects various kinds of input and output devices via a parallel port, a serial port, a keyboard port, a mouse port, and the like.

The program executed by the CPU 902 is stored in a recording medium such as a flexible disk 993, a CD-ROM 992 or an IC (Integrated Circuit) card and provided by the user. The program stored in the recording medium may be compressed or uncompressed. The program is installed into the hard disk drive 908 from the recording medium, retrieved into the RAM 903, and executed by the CPU 902. The program executed by the CPU 902 causes the communication terminal 910 to function as the communication terminals according to the exemplary embodiments described before.

The program stated above may be stored in an external storage medium. As the storage medium, not only the flexible disk 993 and the CD-ROM 992 but also the following storage mediums can be used; an optical recording medium such as a DVD (Digital Versatile Disk) and a PD (Phase Disk), a magneto-optical recording medium such as an MD (MiniDisk), a tape medium, and a semiconductor memory such as an IC card. Moreover, an information sharing system may be provided by using as a recording medium a storage medium such as a hard disk or a RAM provided in a server system connected to a dedicated communication network or the Internet and using as a program via the network.

### Other Exemplary Embodiments

Although the exemplary embodiments of the present invention are described above, the present invention is not limited to the above exemplary embodiments and can be changed and modified in various manners. For example, exemplary embodiments as described below are also included by the present invention.

In the first and second exemplary embodiments, the route information registration part may be configured to, when failing in route solution at the time of unicast communication to a communication terminal recognized as a neighbor communication terminal of the local communication terminal (1 hop neighbor), register route information of the neighbor communication terminal of the local communication terminal into the routing table.

In the second exemplary embodiment, the routing execution control part 224 may be configured to stop part of the functions of the routing control part 212 or fall back, instead of stopping the operation of the routing control part 212. For example, the routing control part 212 may be configured to stop transmission of a message for exchanging topology information with a neighbor communication terminal or make an interval of transmission longer.

In the second exemplary embodiment, the routing execution control part 224 may be configured to restart the operation of the routing control part 212 when failing in route solution at the time of unicast communication to a communication terminal other than a communication terminal recognized as a neighbor communication terminal of the local communication terminal (1 hop neighbor).

In the first and second exemplary embodiments, the route information registration part may be configured to, in a case where route information of a route up to a communication terminal n hops ahead (n denotes an integer equal to or more than 2) can be recognized (calculated) by transmitting and receiving information sharing control messages by the information sharing management part, register the route information of the route up to the communication terminal n hops ahead into the routing table 211. In this case, the routing execution control part 224 may stop the operation of the routing control part in a case where absence of another communication terminal n hops or more away from any of the communication terminals on the network is detected, whereas may restart the operation of the routing control part in a case where presence of another communication terminal n hops or more away from any of the communication terminals on the network is detected.

In the first and second exemplary embodiments, instead of broadcast communication by the information sharing management part, multicast communication may be used. Moreover, unicast communication by the information sharing management part may be not only TCP/IP communication but also DTN (Delay Tolerant Networking) communication.

The present invention is based upon and claims the benefit of priority from Japanese patent application No. 2014-065634, filed on Mar. 27, 2014, the disclosure of which is incorporated herein in its entirety by reference.

### INDUSTRIAL APPLICABILITY

The present invention can be applied to a communication terminal which shares information between an upper layer and a lower layer of a network.

### DESCRIPTION OF NUMERALS

100, 100-1 to 100-3, 200, 200-1 to 200-3, 910 communication terminal
110, 210 lower layer protocol part
111, 111-1 to 111-3, 211, 211-1 to 211-3 routing table
120, 220 upper layer protocol part
121, 221 information sharing management part
122, 222 route information registration part
130, 230 wireless communication part
140, 240 antenna
212 routing control part
223, 223-1 to 223-2 storage part
224 routing execution control part
901 CPU
902 host controller
903 RAM
904 graphic controller
905 display device
906 I/O controller
907 communication I/F
908 hard disk drive
909 CD-ROM drive
910 ROM
911 FD drive
912 I/O chip
992 CD-ROM
993 flexible disk

1. A communication terminal in an ad hoc network, the communication terminal comprising:
a wireless communication part;
a lower layer protocol part configured to operate on a lower layer of the network; and
an upper layer protocol part configured to operate on an upper layer of the network, wherein:
the lower layer protocol part has a routing table holding route information including a destination IP address and a next hop IP address associated with each other; and
the upper layer protocol part has an information sharing management part and a route information registration part, the information sharing management part being configured to transmit and receive a message including an IP address of the local communication terminal to and from a neighbor communication terminal through the wireless communication part by broadcast communication, the route information registration part being configured to register the route information into the routing table, the route information including the IP address included in the message received by broadcast communication as the destination IP address and as the next hop IP address.

2. The communication terminal according to claim 1, wherein the lower layer protocol part has a routing control part configured to exchange topology information with a neighbor communication terminal through the wireless communication part in accordance with a routing protocol and generate the route information to be registered into the routing table.

3. The communication terminal according to claim 2, wherein the route information registration part is configured to register the route information into the routing table only when the routing control part is not operating.

4. The communication terminal according to claim 2, wherein the upper layer protocol part has a routing execution control part configured to control an operation status of the routing control part.

5. The communication terminal according to claim 4, wherein the routing execution control part is configured to stop operation of the routing control part.

6. The communication terminal according to claim 5, wherein the routing execution control part is configured to stop operation of the routing control part when detecting absence of another communication terminal two hops or more away from the local communication terminal or a neighbor communication terminal.

7. The communication terminal according to claim 5, wherein the routing execution control part is configured to restart operation of the routing control part.

8. The communication terminal according to claim 7, wherein the routing execution control part is configured to restart operation of the routing control part when detecting presence of another communication terminal two hops or more away from the local communication terminal or a neighbor communication terminal.

9. The communication terminal according to claim 1, wherein the information sharing management part is configured to perform exchange of a message for sharing information individually with another communication terminal by unicast communication through the wireless communication part.

10. A control method of a communication terminal in an ad hoc network, the communication terminal including a wireless communication part, a lower layer protocol part configured to operate on a lower layer of the network, and an upper layer protocol part configured to operate on an upper layer of the network, the lower layer protocol part having a routing table holding route information including a destination IP address and a next hop IP address associated with each other, the control method comprising:
by the upper layer protocol part, transmitting and receiving a message including an IP address of the local communication terminal to and from a neighbor communication terminal through the wireless communication part by broadcast communication, and registering the route information into the routing table, the route information including the IP address included in the message received by broadcast communication as the destination IP address and as the next hop IP address.

11. (canceled)

12. A non-transitory computer-readable medium storing a program comprising instructions for causing a computer forming a communication terminal in an ad hoc network to function as:
a wireless communication part;
a lower layer protocol part configured to operate on a lower layer of the network; and
an upper layer protocol part configured to operate on an upper layer of the network,
the lower layer protocol part having a routing table holding route information including a destination IP address and a next hop IP address associated with each other,
the upper layer protocol part having an information sharing management part and a route information registration part, the information sharing management part being configured to transmit and receive a message including an IP address of the local communication terminal to and from a neighbor communication terminal through the wireless communication part by broadcast communication, the route information registration part being configured to register the route information into the routing table, the route information including the IP address included in the message received by broadcast communication as the destination IP address and as the next hop IP address.
